(19) United States
(12) Patent Application Publication
(10) Pub. No.: US 2019/0361803 A1
(43) Pub. Date: Nov. 28, 2019

(54) LOGICAL-TO-PHYSICAL TABLE UPDATING METHOD AND STORAGE CONTROLLER

(71) Applicant: Shenzhen EpoStar Electronics Limited CO., Shenzhen (CN)

(72) Inventors: Shih-Tien Liao, Hsinchu City (TW); Yu-Hua Hsiao, Hsinchu County (TW)

(73) Assignee: Shenzhen EpoStar Electronics Limited CO., Shenzhen (CN)

(21) Appl. No.: 16/114,242

(22) Filed: Aug. 28, 2018

(30) Foreign Application Priority Data
May 24, 2018 (TW) 107117742

(51) Int. Cl. G06F 12/02; G06F 3/06

(52) U.S. Cl. CPC G06F 12/0246; G06F 12/0292; G06F 2212/7202; G06F 2212/7201; G06F 3/061

(57) ABSTRACT

A logical-to-physical table updating method and a storage controller are provided. The storage controller includes a processor and a flash memory access circuit. The flash access circuit is coupled to a flash memory. The logical-to-physical table updating method includes: transmitting a write command to the flash memory access circuit by the processor; executing the write command to access the flash memory by the flash memory access circuit; and after the write command is executed by the flash memory access circuit, updating a logical-to-physical table in a random access memory by the flash memory access circuit.

### CROSS-REFERENCE TO RELATED APPLICATION

This application claims the priority benefit of Taiwan application serial no. 107117742, filed on May 24, 2018. The entirety of the above-mentioned patent application is hereby incorporated by reference herein and made a part of this specification.

### BACKGROUND

### Technical Field

The invention relates to a logical-to-physical table updating method and a storage controller, and more particularly, to a logical-to-physical table updating method and a storage controller capable of increasing a command execution speed.

### Description of Related Art

Solid State Drive (SSD) is a very popular storage device in recent years. In general, the SSD receives commands from a host system through a storage controller and accesses a flash memory (i.e., a rewritable non-volatile memory module) according to the received commands.

In the example of FIG. 1, a storage controller 10 may include a storage controller 100, a flash memory 170 and a dynamic random access memory 180. The storage device 10 is, for example, the SSD. The storage controller 100 may include a processor 110, a flash memory access circuit 120, a dynamic random access memory access circuit 130, a static random access memory 140 and an interruption control circuit 150. The interruption control circuit 150 can transmit or receive an interrupt signal through a signal line 101, a signal line 102 and a signal line 103.

The processor 110 can issue a write command (i.e., a page programming command or a page programming request) to the flash memory access circuit 120 through a bus 160. The flash memory access circuit 120 would access the flash memory 170 according to the write command. At this point, the processor 110 would wait for the write command to complete. After the write command is executed, the flash memory access circuit 120 transmits the interrupt signal to the interruption control circuit 150 through signal line 101, and the interruption control circuit 150 then transmits the interrupt signal to the processor 110. After the interrupt signal is received by the processor 110 and it is confirmed that the write command is executed, the processor 110 updates a logical-to-physical table (L2P table) temporarily stored in the static random access memory 140 or the dynamic random access memory 180 according to a physical writing address of the write command The logical-to-physical table is also known as a logical-to-physical address mapping table. However, the process of transmitting the interrupt signal and the processor 110 executing firmware for updating the logical-to-physical table take too much time, thereby reducing an input/output operations per second (IOPS) for system. Therefore, finding a way to improve the input/output operations per second for system is one of the major objectives for persons skilled in the art.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

Accordingly, the invention provides a logical-to-physical table updating method and a storage controller to effectively update the logical-to-physical table in order to increase the input/output operations per second for system.

The invention proposes a logical-to-physical table updating method, which is adapted to a storage controller and a flash memory. The storage controller includes a processor and a flash memory access circuit. The flash access circuit is coupled to a flash memory. The logical-to-physical table updating method includes: transmitting a write command to the flash memory access circuit by the processor; executing the write command to access the flash memory by the flash memory access circuit; and after the write command is executed by the flash memory access circuit, updating a logical-to-physical table in a random access memory by the flash memory access circuit.

In an embodiment of the invention, the processor searches for a physical unit mapped to a logical unit through the logical-to-physical table.

In an embodiment of the invention, the write command includes a physical address, a data source and an update address of the random access memory.

In an embodiment of the invention, the step of executing the write command by the flash memory access circuit includes: writing data corresponding to the data source into the physical address of the flash memory by the flash memory access circuit.

In an embodiment of the invention, the step of updating the logical-to-physical table in the random access memory by the flash memory access circuit includes: writing the physical address into the update address of the random access memory by the flash memory access circuit.

In an embodiment of the invention, the random access memory is a static random access memory (SRAM) or a dynamic random access memory coupled to the storage controller.

The invention proposes a storage controller, which includes a processor and a flash memory access circuit. The flash memory access circuit is coupled to the processor through a bus. The flash access circuit is coupled to a flash memory. The processor transmits a write command to the flash memory access circuit. The flash memory access circuit executes the write command to access the flash memory. After the write command is executed by the flash memory access circuit, the flash memory access circuit updates a logical-to-physical table in a random access memory.

In an embodiment of the invention, the processor searches for a physical unit mapped to a logical unit through the logical-to-physical table.

In an embodiment of the invention, the write command includes a physical address, a data source and an update address of the random access memory.

In an embodiment of the invention, the flash memory access circuit writes data corresponding to the data source into the physical address of the flash memory.

In an embodiment of the invention, after the write command is executed by the flash memory access circuit, the flash memory access circuit writes the physical address into the update address of the random access memory.

In an embodiment of the invention, the random access memory is a static random access memory or a dynamic random access memory coupled to the storage controller.

Based on the above, according to the logical-to-physical table updating method and the storage controller of the invention, after the write command is executed by the flash memory access circuit, the logical-to-physical table in the random access memory is updated by the flash memory access circuit. In this way, the flash memory access circuit no longer needs to transmit the interrupt signal to the processor after the write command is executed, and thus the processor does not have to execute firmware for updating the logical-to-physical table in the random access memory. As a result, the command execution speed may thus be increased, thereby increasing the input/output operations per second for system.

To make the above features and advantages of the disclosure more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional storage device.

FIG. 2 is a block diagram of a storage device according to an embodiment of the invention.

FIG. 3 is a flowchart of a logical-to-physical table updating method according to an embodiment of the invention.

FIG. 4A and FIG. 4B are schematic diagrams for updating the logical-to-physical table according to an embodiment of the invention.

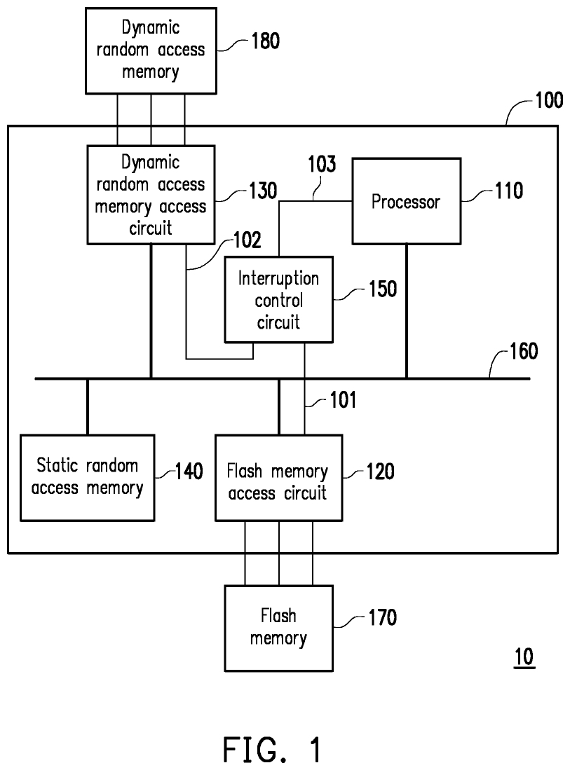

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

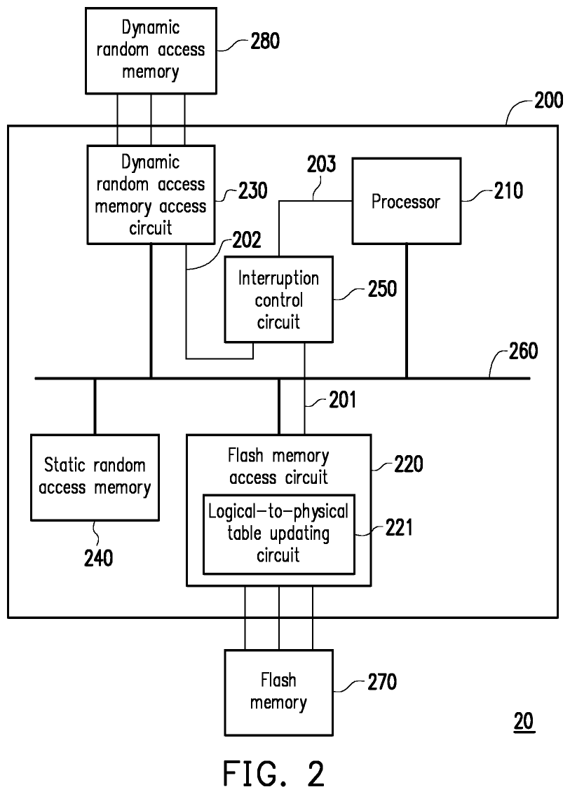

FIG. 2 is a block diagram of a storage device according to an embodiment of the invention.

With reference to FIG. 2, a storage controller 20 may include a storage controller 200, a flash memory 270 and a dynamic random access memory 280. The dynamic random access memory 280 is, for example, SDRAM (Synchronous Dynamic Random Access Memory). DDR SDRAM (Double Data Rate Synchronous Dynamic Random Access Memory), MDDR SDRAM, LPDDR SDRAM, or the like. The storage controller 200 may include a processor 210, a flash memory access circuit 220, a dynamic random access memory access circuit 230, a static random access memory 240 and an interruption control circuit 250. The interruption control circuit 250 can transmit or receive an interrupt signal through a signal line 201, a signal line 202 and a signal line 203. Devices in the storage controller 200 can communicate with one another through a bus 260.

The storage device 20 may be, for example, a flash drive, a memory card, a solid state drive (SSD) or other similar devices. The processor 210 is, for example, a central processing unit (CPU), a micro-processor, other programmable microprocessors, a digital signal processor (DSP), a programmable controller, an application specific integrated circuits (ASIC), a programmable logic device (PLD) or other similar circuit elements. The invention is not limited in this regard. A flash memory 270 may include a rewritable non-volatile memory module.

A flash memory access circuit 220 is configured to receive instructions form the processor 210 to perform writing (a.k.a. programming) and reading operations for data in the rewritable non-volatile memory module. The flash memory access circuit 220 may also perform an erasing operation on the rewritable non-volatile memory module.

For instance, the processor 210 can execute a write command sequence to instruct the flash memory access circuit 220 to write data into the rewritable non-volatile memory module. The processor 210 can execute a read command sequence to instruct the flash memory access circuit 220 to read data from the rewritable non-volatile memory module. The processor 210 can execute an erase command sequence to instruct the flash memory access circuit 220 to perform the erasing operation on the rewritable non-volatile memory module. Each of the write command sequence, the read command sequence and the erase command sequence may include one or more program codes or command codes, which are configured to perform the corresponding writing, reading and erasing operations on the rewritable non-volatile memory module of the flash memory 270. In an embodiment, the processor 210 can further give command sequences of other types to the flash memory access circuit 220 to perform the corresponding operations on the rewritable non-volatile memory module.

In addition, data to be written to the rewritable non-volatile memory module would be converted into a format acceptable by the rewritable non-volatile memory module by the flash memory access circuit 220. Specifically, when the processor 210 intends to access the rewritable non-volatile memory module, the processor 210 sends the corresponding command sequences to the flash memory access circuit 220 to instruct the flash memory access circuit 220 to perform the corresponding operations. For example, the command sequences may include the write command sequence as an instruction for writing data, the read command sequence as an instruction for reading data, the erase command sequence as an instruction for erasing data, and other corresponding command sequences as instructions for performing various memory operations (e.g., changing read voltage levels or performing a garbage collection procedure). The command sequences may include one or more signals, or data from the bus 260. The signals or the data may include command codes and program codes. For example, information such as identification codes and memory addresses are included in the read command sequence.

In this embodiment, the flash memory access circuit 220 further identifies states of logical blocks assigned to the rewritable non-volatile memory module. The flash memory access circuit 220 may also identify states of physical blocks of the rewritable non-volatile memory module. More specifically, after read/write requests are sent to the rewritable non-volatile memory module by the flash memory access circuit 220 according to the read/write commands, the flash memory access circuit 220 identifies whether a state of the storage unit (e.g., the physical block or a physical page, or the corresponding logical block or a logical page) of the rewritable non-volatile memory module is a readiness state. For instance, when the flash memory access circuit 220 identifies that the physical blocks corresponding to the read/write commands are ready for the data transfer, the flash memory access circuit 220 can send a state report indicating that the logical block mapped to said physical block is in the readiness state. In other words, the flash memory access circuit 220 determines whether the state of the logical block is the readiness state by determining whether the physical blocks mapped by the logical block is ready for the data transfer. The flash memory access circuit 220 can actively determine whether the state of the corresponding physical block is ready for the data transfer, and may also passively receive the state report of the corresponding physical block from the rewritable non-volatile memory module. The invention is not intended to limit how the flash memory access circuit 220 identifies whether the physical block/logical block for the data access is in the readiness state.

The rewritable non-volatile memory module of the flash memory 270 may be a SLC (Single Level Cell) NAND flash memory module (i.e., a flash memory module capable of storing one bit in one memory cell), a MLC (Multi Level Cell) NAND flash memory module (i.e., a flash memory module capable of storing two bits in one memory cell), a TLC (Triple Level Cell) NAND flash memory module (i.e., a flash memory module capable of storing three bits in one memory cell), other flash memory modules or any memory module having the same features. The memory cells in the rewritable non-volatile memory module are disposed in an array.

In the present embodiment, the memory cells of the rewritable non-volatile memory module can constitute a plurality of physical programming units, and the physical programming units can constitute a plurality of physical blocks (also known as physical erasing units). Specifically, the memory cells on the same word line (or the same word line layer) can constitute one or more of the physical programming units. If each of the memory cells may be used to store two or more bits, the physical programming units on the same word line (or the same word line layer) may be at least classified into one lower physical programming unit and one upper physical programming unit.

In an embodiment, if each of the memory cells may be used to store two bits, the physical programming units on the same word line (or the same word line layer) may be classified into one lower physical programming unit and one upper physical programming unit. For instance, a least significant bit (LSB) of one memory cell belongs to the lower physical programming unit, and a most significant bit (MSB) of one memory cell belongs to the upper physical programming unit. Generally, a writing speed of the lower physical programming unit is higher than a writing speed of the upper physical programming unit, and/or a reliability of the lower physical programming unit is higher than a reliability of the upper physical programming unit. In an embodiment, if each of the memory cells may be used to store three bits, the physical programming units on the same word line (or the same word line layer) may be classified into one lower physical programming unit, one upper physical programming unit and one extra physical programming unit. For example, the least significant bit (LSB) of one memory cell belongs to the lower physical programming unit, a center significant bit (CSB) of that memory cell belongs to the upper physical programming unit, and the most significant bit (MSB) of that memory cell belongs to the extra physical programming unit.

In the present embodiment, the storage unit used for writing (programming) the data is the physical block. The physical block may also be referred to as the physical erasing unit or a physical unit. The physical erasing unit is the minimal unit for erasing. Namely, each physical erasing unit contains the least number of memory cells to be erased together. Each of the physical blocks has a plurality of physical programming units. The physical programming unit is the physical page or a physical sector. If the physical programming unit is the physical page, these physical programming units usually include a data bit area and a redundancy bit area. The data bit area includes multiple physical sectors configured to store user data, and the redundant bit area is configured to store system data (e.g., an error correcting code).

However, the invention is not limited in this regard. For example, in another embodiment, the data transfer method described in the present embodiment may also be modified and applied to the rewritable non-volatile memory module with the storage unit being the physical programming unit as a unit for writing data.

The storage controller 200 assigns a plurality of logical units for mapping to a plurality of physical units of the rewritable non-volatile memory module for storing the user data, and the host system (not illustrated) accesses the user data stored in the physical units for storing the user data through the logical units. Herein, each of the logical units may be constituted by one or more logic addresses. For example, the logical unit may be a logical block, a logical page or a logical sector. One logical unit may be mapped to one or more physical units, where the physical unit may be one or more physical addresses, one or more physical sectors, one or more physical programming units, or one or more physical erasing units.

For instance, the storage controller 200 would create a logical-to-physical table (L2P table) and a physical-to-logical table (P2L table) for recording a mapping relation between the logical units (e.g., the logical blocks, the logical pages or the logical sectors) assigned to the rewritable non-volatile memory module and the physical units (e.g., the physical erasing units, the physical programming units or the physical sectors). The logical-to-physical table is also known as a logical-to-physical address mapping table, and the physical-to-logical table is also known as a physical-to-logical address mapping table. In other words, the storage controller 200 can search for the physical unit mapped to one logical unit by using the logical-to-physical table, and the storage controller can search for the logical unit mapped to one physical unit by using the physical-to-logical address mapping table. The logical-to-physical (or physical-to-logical address mapping) table may be temporarily stored in the static random access memory 240 or the dynamic random access memory 280. Nonetheless, the technical concept for the mapping relation between the logical units and the physical units is a well-known technical means in the field, which is not repeated hereinafter.

In this embodiment, the flash memory access circuit 220 may also include a logical-to-physical table updating circuit 221, which is configured to automatically update the logical-to-physical table in the static random access memory 240 or the dynamic random access memory 280 after the write command is executed.

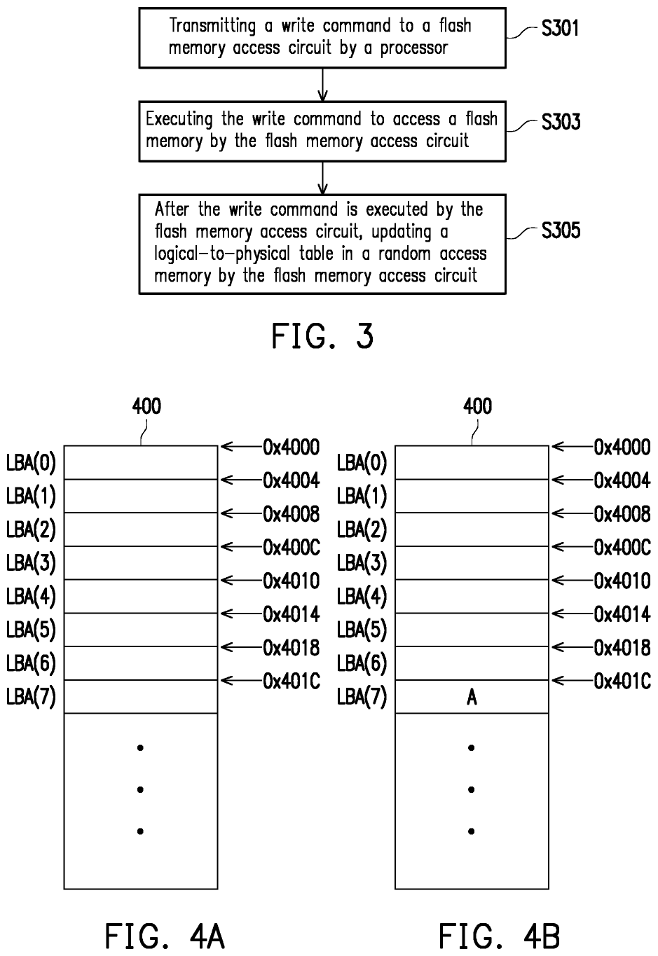

FIG. 3 is a flowchart of a logical-to-physical table updating method according to an embodiment of the invention.

With reference to FIG. 3, in step S301, a write command is transmitted to the flash memory access circuit 220 by the processor 210.

Specifically, the write command may include an operation code (op code), a physical address, a data source and an update address of the random access memory. The random access memory may be the static random access memory 240 or the dynamic random access memory 280. The operation code indicates a type of the operation to be executed. The physical address is a physical address of the flash memory 270 where the write command writes data to. The data source records the logical unit corresponding to a location of the write data of the write command The update address of the random access memory records an address of the logical-to-physical table to be updated in the random access memory.

In step S303, the write command is executed to access the flash memory 270 by the flash memory access circuit 220. Specifically, the flash memory access circuit 220 writes the write data corresponding to the data source into the physical address of the flash memory 270.

In step S305, after the write command is executed by the flash memory access circuit 220, a logical-to-physical table in a random access memory is updated by the flash memory access circuit 220. Specifically, when the flash memory access circuit 220 has successfully written the write data into the physical address of the flash memory 270, the logical-to-physical table updating circuit 221 writes that physical address into the update address of the random access memory to complete an updating operation of the logical-to-physical table.

FIG. 4A and FIG. 4B are schematic diagrams for updating the logical-to-physical table according to an embodiment of the invention.

In FIG. 4A, a logical-to-physical table 400 is recorded in one address segment of the random access memory, such as one address segment starting from 0x4000. A size of each field in the logical-to-physical table 400 may be four byte, where each field is used for recording the physical address corresponding to the logical unit. In this embodiment, the logical unit of the storage device 20 is represented by a logical block address (LBA). For example, the storage device 20 includes logical units LBA(0), LBA(1), . . . , LBA(N). Accordingly, an address 0x4000 may correspond to LBA(0) and the address 0x4000 records the physical address mapped to LBA(0); an address 0x4004 may correspond to LBA(1) and the address 0x4004 records the physical address mapped to LBA(1); and the rest may be deduced by analogy.

In FIG. 4B, it is assumed that the write command indicates to write data with the data source of LBA(7) into a physical address A of the flash memory 270. In this case, the write command also includes the update address of the logical-to-physical table in the random access memory, i.e., 0x401C. When the flash memory access circuit 220 has successfully written data of LBA(7) into the physical address A of the flash memory 270, the logical-to-physical table updating circuit 221 writes that physical address A into the address 0x401C in the random access memory to complete the updating operation of the logical-to-physical table.

In summary, according to the logical-to-physical table updating method and the storage controller of the invention, after the write command is executed by the flash memory access circuit, the logical-to-physical table in the random access memory is updated by the logical-to-physical table updating circuit in the flash memory access circuit. In this way, the flash memory access circuit no longer needs to transmit the interrupt signal to the processor after the write command is executed, and thus the processor does not have to execute firmware for updating the logical-to-physical table in the random access memory. As a result, the command execution speed may thus be increased, thereby increasing the input/output operations per second for system.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A logical-to-physical table updating method, adapted to a storage controller and a flash memory, the storage controller comprising a processor and a flash memory access circuit, the flash memory access circuit being coupled to the flash memory, the logical-to-physical table updating method comprising:
transmitting a write command to the flash memory access circuit by the processor;
executing the write command to access the flash memory by the flash memory access circuit; and
after the write command is executed by the flash memory access circuit, updating a logical-to-physical table in a random access memory by the flash memory access circuit.

2. The logical-to-physical table updating method according to claim 1, wherein the processor searches for a physical unit mapped to a logical unit through the logical-to-physical table.

3. The logical-to-physical table updating method according to claim 1, wherein the write command comprises a physical address, a data source and an update address of the random access memory.

4. The logical-to-physical table updating method according to claim 3, wherein the step of executing the write command by the flash memory access circuit comprises: writing data corresponding to the data source into the physical address of the flash memory by the flash memory access circuit.

5. The logical-to-physical table updating method according to claim 3, wherein the step of updating the logical-to-physical table in the random access memory by the flash memory access circuit comprises: writing the physical address into the update address of the random access memory by the flash memory access circuit.

6. The logical-to-physical table updating method according to claim 1, wherein the random access memory is a static random access memory (SRAM) or a dynamic random access memory (DRAM) coupled to the storage controller.

7. A storage controller, comprising:
a processor; and
a flash memory access circuit, coupled to the processor through a bus, wherein the flash memory access circuit is coupled to a flash memory, wherein
the processor transmits a write command to the flash memory access circuit;
the flash memory access circuit executes the write command to access the flash memory; and
after the write command is executed by the flash memory access circuit, the flash memory access circuit updates a logical-to-physical table in a random access memory.

8. The storage controller according to claim 7, wherein the processor searches for a physical unit mapped to a logical unit through the logical-to-physical table.

9. The storage controller according to claim 7, wherein the write command comprises a physical address, a data source and an update address of the random access memory.

10. The storage controller according to claim 9, wherein the flash memory access circuit writes data corresponding to the data source into the physical address of the flash memory.

11. The storage controller according to claim 9, wherein after the write command is executed by the flash memory access circuit, the flash memory access circuit writes the physical address into the update address of the random access memory.

12. The storage controller according to claim 7, wherein the random access memory is a static random access memory or a dynamic random access memory coupled to the storage controller.
